(19) United States
(12) Patent Application Publication
(10) Pub. No.: US 2017/0131840 A1
(43) Pub. Date: May 11, 2017

(54) ALGORITHMS AND IMPLEMENTATION OF TOUCH PRESSURE SENSORS

(71) Applicant: Corning Incorporated, Corning, NY (US)

(72) Inventors: Oberon Denaci Deichmann, Corning, NY (US); Jacques Gollier, Redmond, WA (US); William James Miller, Horseheads, NY (US); Lucas Wayne Yeary, Corning, NY (US)

(21) Appl. No.: 15/319,176

(22) PCT Filed: May 28, 2015
(86) PCT No.: PCT/US15/32884

§ 371 Date: Dec. 15, 2016

Related U.S. Application Data
(60) Provisional application No. 62/013,120, filed on Jun. 17, 2014.

(51) Int. Cl. G06F 3/041; G06F 3/044

(52) U.S. Cl. CPC G06F 3/0418; G06F 3/044; G06F 3/0412; G06F 2203/04104; G06F 2203/04105

(57) ABSTRACT

A pressure-sensing touch system for an electronic display includes a plurality of pressure sensors and a controller. Each pressure sensor of the plurality of pressure sensors is configured to generate a signal indicative of pressure applied to a surface of the electronic display. The controller is configured to (i) receive spatial coordinates of a plurality of touch events simultaneously occurring on the electronic display, (ii) select a subset of the plurality of pressure sensors, and (iii) calculate pressure values respectively corresponding to the plurality of touch events based on the spatial coordinates and the signals from the selected subset. The selected subset is a proper subset.

This application claims the benefit of priority under 35 U.S.C. §119 of U.S. Provisional Application Ser. No. 62/013,120, filed on Jun. 17, 2014, the content of which is relied upon and incorporated herein by reference in its entirety.

### FIELD

The present disclosure relates to touch-sensitive devices, and in particular to touchscreen systems and methods for sensing touch-screen displacement.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The market for displays and other devices (e.g., keyboards) having non-mechanical touch functionality is rapidly growing. As a result, touch-sensing techniques have been developed to enable displays and other devices to have touch functionality. Touch-sensing functionality is gaining wider use in mobile device applications, such as smart phones, e-book readers, laptop computers and tablet computers.

Touch-sensitive surfaces have become the preferred method where users interact with a portable electronic device. To this end, touch systems in the form of touchscreens have been developed that respond to a variety of types of touches, such as single touches, multiple touches, and swiping. Some of these systems rely on light-scattering and/or light attenuation based on making optical contact with the touch-screen surface, which remains fixed relative to its support frame. An example of such a touch-screen system is described in U.S. Patent Application Publication No. 2011/0122091.

Commercial touch-based devices such as smart phones currently detect an interaction from the user as the presence of an object (i.e. finger, stylus) on or near the display of the device. This is considered a user input and can be quantified by determining if an interaction has occurred, calculating the X-Y location of the interaction, and determining the length of interaction.

Touch screen devices are limited in that they can only gather location and timing data during user input. There is a need for additional input parameters, such as force, that are intuitive for the user. By using more sophisticated processing of touch events and input gestures, the user may be able to more efficiently and more intuitively communicate their intent to the electronic device.

### SUMMARY

A pressure-sensing touch system for an electronic display includes a plurality of pressure sensors and a controller. Each pressure sensor of the plurality of pressure sensors is configured to generate a signal indicative of pressure applied to a surface of the electronic display. The controller is configured to (i) receive spatial coordinates of a plurality of touch events simultaneously occurring on the electronic display, (ii) select a subset of the plurality of pressure sensors, and (iii) calculate pressure values respectively corresponding to the plurality of touch events based on the spatial coordinates and the signals from the selected subset. The selected subset is a proper subset.

In other features, the controller is configured to, for the plurality of touch events, (i) determine noise values for each of a plurality of candidate subsets of the plurality of pressure sensors and (ii) designate the candidate subset having the lowest noise values as the selected subset. In other features, the controller is configured to, in response to the lowest noise values exceeding a predetermined noise threshold, apply a low-pass filter to the signals of the plurality of pressure sensors. In other features, the controller is configured to, in response to the spatial coordinates of two of the touch events being closer than a predetermined distance threshold, calculate a combined pressure value for the two touch events.

In other features, the controller is configured to calibrate the signals from the plurality of pressure sensors while no touch events are occurring on the electronic display. In other features, the controller is configured to continue calibrating the signals from the plurality of pressure sensors as long as no touch events are occurring on the electronic display. In other features, the electronic display has a generally rectangular shape with first and second short sides and first and second long sides, first and second sensors of the plurality of pressure sensors are located along the first short side, third and fourth sensors of the plurality of pressure sensors are located along the second short side, a fifth sensor of the plurality of pressure sensors is located along the first long side, and a sixth sensor of the plurality of pressure sensors is located along the second long side.

In other features, the fifth sensor is centered along the first long side, and the sixth sensor is centered along the second long side. In other features, the electronic display includes a viewable area and a bezel surrounding the viewable area, and the plurality of pressure sensors are located underneath the bezel. In other features, the electronic display includes a first surface against which the touch events apply pressure, the first surface deflects in response to the applied pressure, and a first sensor of the plurality of pressure sensors includes an electromagnetic sensor that detects deflection of the first surface. In other features, a reflector is attached to an underside of the first surface. In other features, the first sensor includes an electromagnetic emitter. In other features, the electromagnetic emitter emits infrared light. In other features, the first surface pivots against a fulcrum, and the first sensor is located between the fulcrum and a center of the electronic display.

In other features, a viscoelastic material is present between the fulcrum and the first surface, the pressure-sensing touch system further comprises an additional electromagnetic sensor that detects deflection of the first surface, and the additional electromagnetic sensor is located on an opposite side of the fulcrum from the center of the electronic display. In other features, the controller is further configured to compensate, based on deflection detected by the additional electromagnetic sensor, for displacement of the viscoelastic material.

In other features, a display system includes the pressure-sensing touch system, the electronic display, and a position-sensing device configured to generate the coordinates. In other features, the touch events include at least one of (i) contact between a hand of a user and the electronic display and (ii) contact between an electrically-conductive implement and the electronic display. In other features, the position-sensing device comprises a capacitive multi-touch-sensitive device. In other features, a mobile computing device includes the display system.

A method of operating a pressure-sensing touch system for an electronic display includes, from each pressure sensor of a plurality of pressure sensors, receiving a signal indicative of pressure applied to a surface of the electronic display. The method further includes receiving spatial coordinates of a plurality of touch events simultaneously occurring on the electronic display. The method further includes selecting a subset of the plurality of pressure sensors. The selected subset is a proper subset. The method further includes calculating pressure values respectively corresponding to the plurality of touch events based on the spatial coordinates and the signals from the selected subset.

In other features, the method further includes, in response to the plurality of touch events, (i) determining noise values for each of a plurality of candidate subsets of the plurality of pressure sensors and (ii) from the plurality of candidate subsets, designating the candidate subset having the lowest noise values as the selected subset. In other features, the method further includes, in response to the lowest noise values exceeding a predetermined noise threshold, applying a low-pass filter to the signals of the plurality of pressure sensors.

In other features, the method further includes, in response to the spatial coordinates of two of the touch events being closer than a predetermined distance threshold, calculating a combined pressure value for the two touch events. In other features, the method further includes calibrating the signals from the plurality of pressure sensors while no touch events are occurring on the electronic display. In other features, the method further includes continuing to calibrate the signals from the plurality of pressure sensors as long as no touch events are occurring on the electronic display.

In other features the electronic display has a generally rectangular shape with first and second short sides and first and second long sides, first and second sensors of the plurality of pressure sensors are located along the first short side, third and fourth sensors of the plurality of pressure sensors are located along the second short side, a fifth sensor of the plurality of pressure sensors is centered along the first long side, and a sixth sensor of the plurality of pressure sensors is centered along the second long side.

In other features, the electronic display includes a first surface against which the touch events apply pressure, the first surface pivots against a fulcrum in response to the applied pressure, a viscoelastic material is present between the fulcrum and the first surface, and the method further includes compensating the signal from the first sensor based on displacement of the viscoelastic material. In other features, the pressure-sensing touch system further includes an additional electromagnetic sensor that detects deflection of the first surface and generates a deflection signal. The additional electromagnetic sensor is located on an opposite side of the fulcrum from the center of the electronic display. The method further includes determining the displacement of the viscoelastic material based on the deflection signal.

A non-transitory computer-readable medium stores instructions. The instructions include, from each pressure sensor of a plurality of pressure sensors, receiving a signal indicative of pressure applied to a surface of an electronic display. The instructions further include receiving spatial coordinates of a plurality of touch events simultaneously occurring on the electronic display. The instructions further include selecting a subset of the plurality of pressure sensors. The subset is a proper subset. The instructions further include calculating pressure values respectively corresponding to the plurality of touch events based on the spatial coordinates and the signals from the selected subset.

In other features, the instructions further include, in response to the plurality of touch events, (i) determining noise values for each of a plurality of candidate subsets of the plurality of pressure sensors and (ii) from the plurality of candidate subsets, designating the candidate subset having the lowest noise values as the selected subset. In other features, the instructions further include, in response to the lowest noise values exceeding a predetermined noise threshold, applying a low-pass filter to the signals of the plurality of pressure sensors.

In other features, the instructions further include, in response to the spatial coordinates of two of the touch events being closer than a predetermined distance threshold, calculating a combined pressure value for the two touch events. In other features, the instructions further include calibrating the signals from the plurality of pressure sensors while no touch events are occurring on the electronic display. In other features, the instructions further include continuing to calibrate the signals from the plurality of pressure sensors as long as no touch events are occurring on the electronic display.

In other features, the electronic display includes a first surface against which the touch events apply pressure, the first surface pivots against a fulcrum in response to the applied pressure, and a viscoelastic material is present between the fulcrum and the first surface. The instructions further include compensating the signal from the first sensor based on displacement of the viscoelastic material. In other features, an additional electromagnetic sensor that detects deflection of the first surface and generates a deflection signal is located on an opposite side of the fulcrum from the center of the electronic display. The instructions further include determining the displacement of the viscoelastic material based on the deflection signal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example touchscreen device according to the principles of the present disclosure;

FIG. 2A is a simplified cross-sectional view of a touchscreen device including a deflection sensor

FIG. 2B is a simplified cross-sectional view in which a cover of the cover of the touchscreen device has been displaced by an applied force;

FIG. 3A is a graphical depiction of response sensitivity for an example touchscreen using a single sensor.

FIG. 3B is a graphical depiction of a touchscreen display using four sensors.

FIG. 4 is a front view of an example touchscreen assembly including a screen shot of an example game application.

FIG. 5A is a graphical depiction of response sensitivity for an example touchscreen assembly including four sensors in which simultaneous close touches are being sensed.

FIG. 5B is a graphical depiction of response sensitivity for an example touchscreen assembly including four sensors in which a touch is occurring at a location of minimum sensitivity.

FIG. 6A is a noise level map for a second simultaneous touch on a four-sensor touchscreen assembly where a first touch remains at the center of the touchscreen assembly.

FIG. 6B is a noise level map for a second simultaneous touch on a six-sensor touchscreen assembly where a first touch remains at the center of the touchscreen assembly.

FIG. 7 is a chart of force sensor response over time versus an ideal response profile.

FIG. 8 is a simplified cross-sectional view of a touchscreen assembly including an additional deflection sensor used to compensate for viscoelastic material drift.

FIG. 9 is a chart of example sensor response when compensated by data from a second sensor such as that shown in FIG. 8.

FIG. 10 is a chart of sensor response of an example signal from a compensation sensor overlaid with a low-pass-filtered version of the signal.

FIG. 11 is a flowchart of an example operation of a force determination controller.

FIG. 12 A is flowchart of an example operation for calculating a single force.

FIG. 12B is a flowchart depicting example operation of calculating forces for multiple touches.

FIG. 13 is a flowchart of an example operation of compensating sensor data.

FIG. 14 is a flowchart depicting additional example operation of sensor compensation based on a second sensor.

FIG. 15 is a flowchart depicting additional example operation of sensor compensation based on a second sensor.

In the drawings, reference numbers may be reused to identify similar and/or identical elements.

### DETAILED DESCRIPTION

When a user touches a touchscreen, current touch technologies can accurately determine where the touch occurred. The user may touch a touchscreen using their finger, a stylus, or any other suitable implement. The touchscreen may implement various forms of position identification, including capacitive sensing, resistive sensing, and surface acoustic wave sensing. In various implementations, capacitive sensing may require that the implement the user uses to touch the touchscreen has some amount of electrical conductivity.

With current technology, a touchscreen may determine the position of multiple, simultaneous touches including, for example, two simultaneous touches, three simultaneous touches, four simultaneous touches, five simultaneous touches, or ten simultaneous touches. While the locations of touches can be determined using current technology, there are opportunities to enhance the user experience by accurately determining the pressure/force applied by the touch.

The present disclosure describes how location data of touches can be used to improve accuracy of the determination of the force of those touches, especially in situations where multiple touches are occurring simultaneously. The present disclosure includes descriptions of physical arrangements of force sensor placement that may improve force accuracy in various touch scenarios. In addition, approaches are discussed for processing and correcting force sensor data.

Further, force sensor readings may drift over time due to time constants inherent in the sensors themselves or physical processes having a slow time constant. For example, a flexible coupling between a cover of a touchscreen and a pivot point may deform over time. This may be the case when a viscoelastic material, such as a pressure-sensitive adhesive, is used to retain the cover. Discussed below are approaches for correcting force sensor data for these drift errors, including processing of the data as well as inclusion of additional sensors.

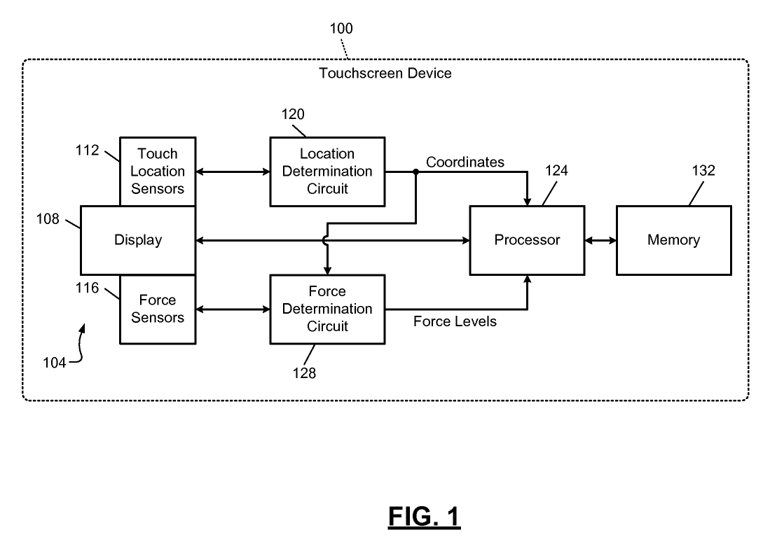

In FIG. 1, a touchscreen device 100 includes a touchscreen assembly 104. The touchscreen assembly 104 includes a display 108, which may include a variety of components such as a backlight, a liquid crystal layer, a color filter layer, a polarizing layer, a thin film transistor layer, and a cover. The cover may be made of glass, ceramic, or glass-ceramic. An example glass material is Gorilla® glass from Corning Incorporated of Corning, N.Y. Integrated with the display 108 are touch location sensors 112. Although depicted in FIG. 1 separately, the touch location sensors 112 may form one or more layers of the display 108.

Also associated with the display 108 are one or more force sensors 116. As shown in more detail below, the force sensors 116 may be located below a non-viewable portion of the display 108, such as underneath a bezel portion of the display 108.

A location determination circuit 120 controls the touch location sensors 112 and senses the locations of touches applied to the display 108. The coordinates of these touches are relayed to a processor 124 and a force determination circuit 128. The force determination circuit 128 controls the force sensors 116 and reads force data from the force sensors 116. The force determination circuit 128 uses the force sensor data and the coordinates to determine force levels corresponding to the touches. These force levels are provided to the processor 124.

The processor 124 executes instructions from a memory 132. As described in more detail below, the memory 132 may include volatile random access memory, flash memory, read-only memory, etc. In various implementations the memory 132 may serve as a working space and as a cache for longer-term storage (not shown). The processor 124 controls the image shown on the display 108 and processes the coordinates from the location determination circuit 120 and the force levels from the force determination circuit 128 to determine user inputs.

The processor 124 may execute user applications, such as games, email and web clients, and productivity software and may also perform communication tasks including wireless local area networking, cellular communication, and wireless personal area networking. In various implementations, some of this functionality may be performed by other circuits —for example only, a graphics processor may render the image to be shown on the display 108. Additionally or alternatively, the processor 124 may integrate some or all of the functionality of the location determination circuit 120 and/or the force determination circuit 128.

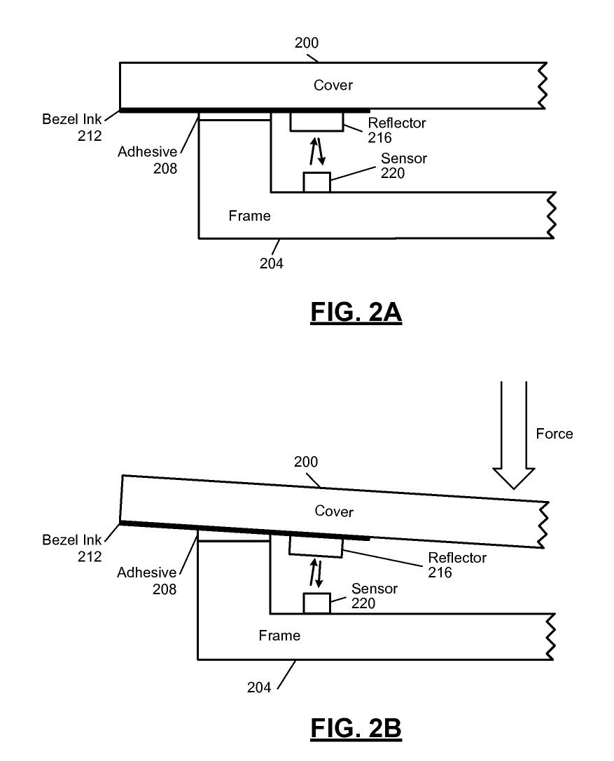

FIG. 2A is a cross-sectional view of an example implementation of a force sensor. A cover 200, such as a transparent glass cover, is supported by a frame 204. The cover may be attached to the frame via any number of ways, including for example via mechanical or adhesive mechanisms. For example, the cover 200 is bonded to the frame 204 using an adhesive 208. Bezel ink 212 may be applied to either face of the glass cover to create an opaque layer on a portion of the cover 200 where an image will not be displayed.

A reflector 216 may be optionally mounted to the cover 200 and a sensor 220 is mounted across from the reflector 216 in a cavity between the frame 204 and the cover 200. In some embodiment, the reflector is absent and the cover glass 200 acts as a reflector for sensor 220. In various implementations, the reflector 216 and the sensor 220 may be located underneath (or, when looking at the touchscreen from the front, behind) the bezel ink 212. The sensor 220 transmits light toward the reflector 216, which is reflected back to the sensor 220. The light may be in a visible portion of the spectrum or in an invisible, such as infrared, portion. Example light sources include light emitting diodes, laser diodes, optical-fiber lasers, etc. The sensor 220 may include an array of photodiodes, a large-area photosensor, a linear photosensor, a charge coupled device, etc. An example of the sensor 220 is an OSRAM proximity sensor type SFH 7773, which uses an 850 nm light source and a linear light sensor.

Alternatively, the reflector and sensor may be reversed in position such that the sensor is located on the cover 200 and the reflector 216 is located on the frame 204.

In FIG. 2B, a downward force is applied to the cover 200 by a user touch. The cover 200 pivots against a portion of the frame 204 that acts as a fulcrum. The pattern of light reflected by the reflector 216 then falls onto a different portion of the sensor 220. The sensor 220 can detect an amount of deflection of the cover 200 based on how far the light pattern moves across the photosensitive portions of the sensor 220.

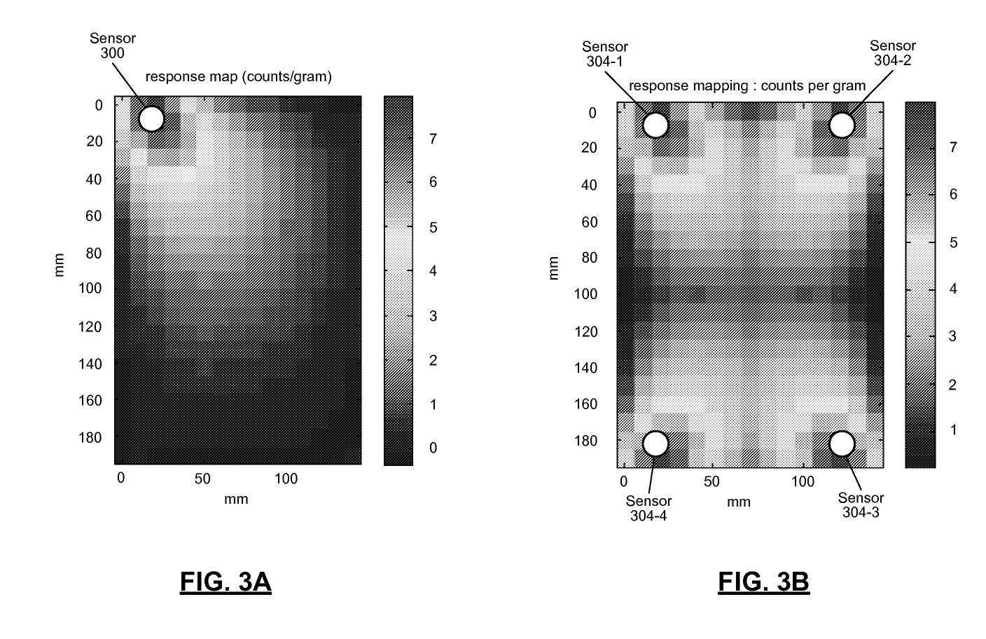

The embodiments disclosed herein are applicable to a display of any size with the only changes possibly necessary being the number and proximity of the sensors. FIG. 3A shows an example touchscreen represented by a rectangle having a height of approximately 200 mm and a width of approximately 150 mm. A sensor 300 is positioned near a corner of the touchscreen. Shading illustrates the sensitivity of the sensor 300 to a user touch. The sensitivity is highest when the touch is close to the sensor 300, decreases as the touch moves away from the sensor, and is least sensitive at a far side of the touchscreen from the sensor 300.

The response of the sensor 300 is very delocalized, meaning that the sensor 300 will respond to a touch occurring anywhere on the surface of the touchscreen, not simply at the location of the sensor 300. The coordinates at which the touch occurred can be used to determine how close the touch is to the sensor 300, and therefore how sensitive the sensor 300 is to that particular touch.

Because the sensor 300 is less sensitive to a touch that is further away from the sensor 300, estimating the actual applied force requires scaling up the value read by the sensor 300. The sensitivity graphically displayed in FIG. 3A may be stored in a two-dimensional array or “look-up” table in persistent memory. When a touch is detected, the location of the touch can be used to look up the sensitivity, which may be measured in, e.g., counts per gram. The force of the touch can be calculated by dividing the response of the sensor (for example, measured in counts) by the determined sensitivity. However, as the sensitivity decreases, this division may end up being a multiplication by a larger and larger number. This causes any noise present in the response of the sensor 300 to be amplified, possibly leading to noisy and inaccurate force data.

In FIG. 3B, four sensors, 304-1, 304-2, 304-3, and 304-4 (collectively, sensors 304) are located near corners of the touchscreen. With the four sensors 304, the sensitivity to touch of the touchscreen is fairly high throughout the touchscreen. To generate the sensitivity map of FIG. 3B, for each point of the touchscreen, the closest one of the sensors 304 is selected and the sensitivity of that sensor is used. This essentially creates horizontal and vertical symmetry for the sensor of FIG. 3A and leaves only a band in the middle of the touchscreen with less than ideal sensitivity. When calculating the force of a touch, the nearest one of the sensors 304 is selected and the sensitivity of that sensor at the location of the touch is determined. The measured force from that sensor is then divided by the determined sensitivity to result in an estimation of the applied force.

To improve accuracy in some situations, more than one of the sensors 304 may be used in calculating the force of the touch. For example, the following equation can be used to calculate the force for each sensor:

$${F}_{i} = \frac{{R}_{i}}{{S}_{i} ( x 0 , y 0 )}$$

where Fᵢ is the calculated force for sensor i, Rᵢ is the measured response of sensor i (which may be measured in a unitless value called counts), and Sᵢ (x0, y0) is the predetermined sensitivity of sensor i at the location of the touch (coordinates x0, y0).

The force of the touch can then be estimated using a weighted sum of the estimates from the individual sensors as shown here:

F=Σσᵢ*Fᵢ

where F is the aggregate force, σᵢ is the weight assigned to sensor i, Fᵢ is the calculated force for sensor i, and the weights sum to one (Σσᵢ=1).

The weights αᵢ may be determined dynamically based on the sensitivity of each sensor. In various implementations, the sensor having the lower sensitivity may be assigned a weight of zero, thereby ignoring its contribution.

When multiple touches are present, the force measured by each sensor may generally be a linear superposition of the sensor responses to each of the touches. For example, the response of sensor i (Rᵢ) to a simultaneous first touch (at coordinates x1,y1) and second touch (at coordinates x2,y2) is:

Rᵢ=Sᵢ(x1,y1)F₁+Sᵢ(x2,y2)F₂

where F₁ is the force applied by the first touch, F₂ is the force applied by the second touch, and Sᵢ is the is the sensitivity of sensor i at a specified touch location.

For a specified pair of sensors providing measured responses R₁ and R₂, the response equations can be written in a matrix form as follows:

$$( \begin{matrix}{R}_{1} \\ {R}_{2}\end{matrix} ) = ( \begin{matrix}a & b \\ c & d\end{matrix} ) ( \begin{matrix}{F}_{1} \\ {F}_{2}\end{matrix} )$$

The coefficients a and b are the sensitivities of the first sensor to the first and second touches, respectively, while the coefficients c and d are the sensitivities of the second sensor to the first and second touches, respectively. Specifically, coefficient a corresponds to S₁(x1,y1) and coefficient b corresponds to S₁(x2,y2), where S₁ is the sensitivity of the first sensor at the specified touch coordinates. Further, coefficient c corresponds to S₂(x1,y1) and coefficient d corresponds to S₂(x2,y2), where S₂ is the sensitivity of the first sensor at the specified touch coordinates.

The forces can be solved for by determining the inversion of the two-by two-matrix, as follows:

$$( \begin{matrix}{F}_{1} \\ {F}_{2}\end{matrix} ) = \frac{1}{ad - bc} ( \begin{matrix}d & - b \\ - c & a\end{matrix} ) ( \begin{matrix}{R}_{1} \\ {R}_{2}\end{matrix} )$$

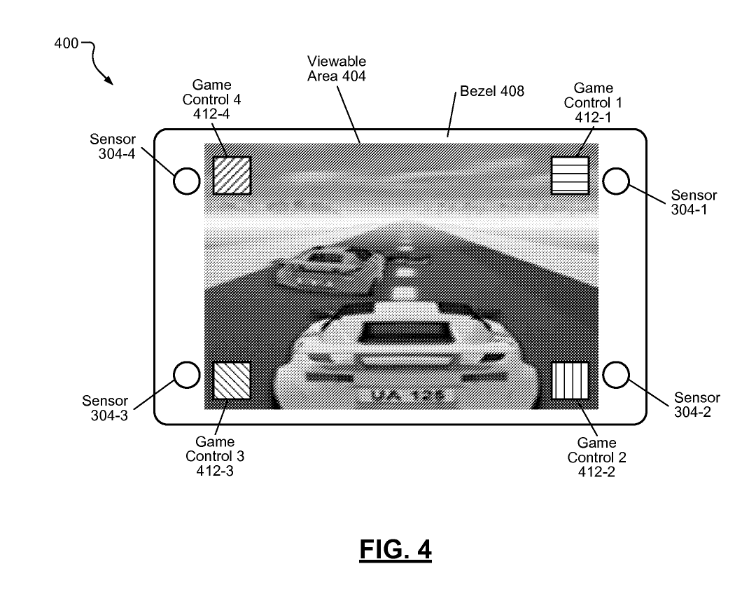

In FIG. 4, a simplified illustration of a touchscreen device 400 includes a viewable area 404 surrounded by a bezel 408. The sensors 304 may be located behind the bezel 408. In FIG. 4, the viewable area 404 is shown with a screenshot of a racing game. The racing game may have predefined control areas 412-1, 412-2, 412-3, and 412-4. The game controls 412 may correspond to, for example, accelerating, braking, and turning and in a real game may be more aesthetically pleasing than squares with different hatching patterns.

Because the game control areas 412 are close to locations of the sensors 304, the sensitivity of each of the sensors 304 is high with respect to the game control that is closest to the sensor and low with respect to the remaining game controls. As a result, the coefficients b and c in the matrix get close to zero and noise from the sensors 304 is not amplified.

However, if simultaneous touches are not constrained to specific control locations near sensor locations, noise may become an issue. Coefficients can be redefined according to the following equation by dividing out the determinant:

$$\frac{1}{ad - bc} ( \begin{matrix}d & - b \\ - c & a\end{matrix} ) = ( \begin{matrix}m & n \\ o & p\end{matrix} )$$

The noise contributed by the first and second sensors to the estimated forces can then be calculated as follows;

σ_{F1}=\sqrt{m²+n²}*σₛ

σ_{F2}=\sqrt{o²+p²}*σₛ

where σ_{F1} is the noise contributed by the first and second sensors to the measurement of force (F₁) at the first touch location, σ_{F2} is the noise contributed by the first and second sensors to the measurement of force (F₂) at the second touch location, and σₛ is the raw measurement noise present at the first and second sensors.

These noise amplification values (i.e., the quantities \sqrt{m²+n²} and \sqrt{o²+p²}) can be calculated for every possible pair of sensors and then the pair of sensors that has the lowest noise amplification values can be selected. The raw measurement noise (σₛ) may be ignored when making this selection as it is common to all of the sensors. The selected pair of sensors then can be used to estimate the forces corresponding to simultaneous touches.

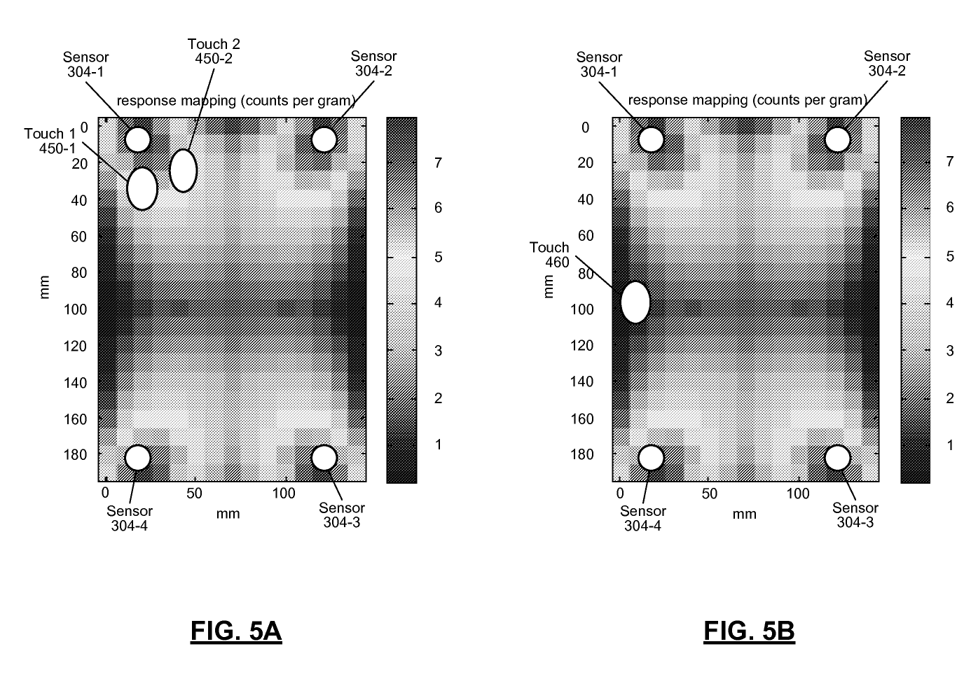

In FIG. 5A, touches 450-1 and 450-2 are applied simultaneously close to each other and closer to the sensor 304-1 than to the other sensors 304. Because the distance between the touches 450 is much smaller than the distance between the touches 450 and any of the sensors 304 other than the sensor 304-1, the other sensors 304 are not able to provide meaningful data that would allow the force signal from the sensor 304-1 to be accurately split between the touch 450-1 and the touch 450-2.

One approach for dealing with this situation is to treat the touches 450 as a single touch and to determine the force corresponding to that hypothetical single touch. The force can then be divided evenly between the touches 450. This may be the most accurate approach when additional data is not available to help apportion the overall force between the two touches 450.

In FIG. 5B, a touch 460 is shown in an area of low sensitivity for all of the sensors 304. The measured sensor 304-1 and the sensor 304-4 may be used estimate the force of the touch 460. However, because of the distance of the touch 460 from the sensors 304, the amount of noise in the reading may be high.

A touchscreen assembly may be designed so that the touchscreen does not include any points at which the sensitivity of all of the sensors 304 is below a threshold. If one or more of these points exists, then the sensors 304 may be relocated and/or additional sensors added until the criterion is satisfied. For example the threshold may be N/20 where N is the noise of one of the sensors 304. As the noise of the sensors 304 goes up, or as the sensitivities of the sensors 304 goes down, or as the size of the touchscreen assembly goes up, the number of sensors may need to be increased.

To allow differentiating between two touches that are close to a single sensor, such as the situation shown in FIG. 5A, additional constraints may be imposed. For example, a design constraint may require that there is no point on the touchscreen for which there is only one sensor having a sensitivity greater than a certain threshold. In other words, for every point on the touchscreen, there are at least two sensors whose sensitivities are above the threshold.

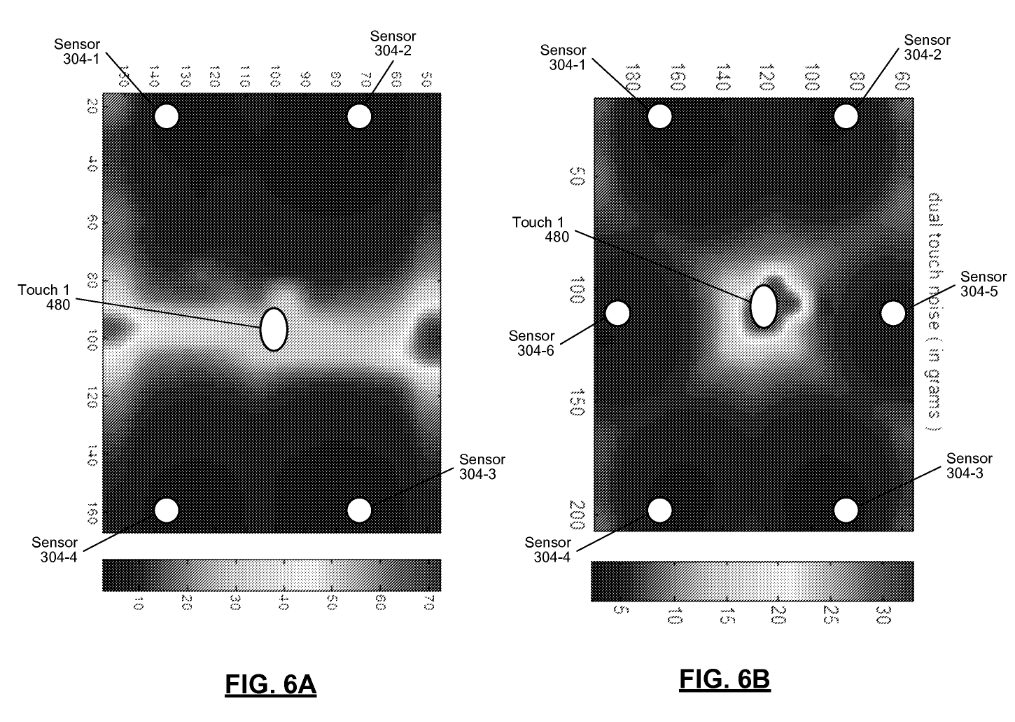

In FIG. 6A, a noise level map displays noise levels as a function of the location of a second touch when a first touch remains fixed at the center of the touchscreen. The noise is high while the second touch is located along the line of symmetry between the sensors 304-1 and 304-2 and the sensors 304-3 and 304-4. The noise reaches peak values at the edge of the display along this line of symmetry.

Once the second touch moves off of the line of symmetry the noise levels drop dramatically. For example, as the second touch moves up toward the sensors 304-1 and 304-2, the first touch can then be accurately gauged by the sensors 304-3 and 304-4 and the noise decreases because the force from the two touches can be more accurately differentiated.

Applications using this touchscreen may be programmed so that the user interface generally does not solicit simultaneous touches along this line of symmetry. In addition, when the locations of touches indicate that the touches are along this line of symmetry, averaging may be applied to the signals from the sensors 304. Averaging may reduce noise so that when the signals from the sensors 304 are amplified, the amount of resulting noise if reduced. The trade-off is delayed responsiveness to changes in force.

In FIG. 6B, another approach is to add additional sensors 304-5 and 304-6 to the line of symmetry. Now, when the first touch 480 is fixed at the center of the touchscreen, the amount of noise for a second touch only increases substantially when the second touch becomes very close to the first touch 480. For a rectangular screen, one advantageous placement of six sensors is as shown on FIG. 6B, with two sensors placed along each of the short sides and one sensor centered on each of the long sides.

The spacing between the pair of sensors on each of the short sides may be determined by calculating the maximum amount of noise as potential locations of the sensors are investigated. The spacing between the sensors on the short sides may then be fixed once a lowest noise condition is determined. For example only, each of the sensors on the short side may be positioned at quarter points (i.e., located one quarter of the width in from the long side) or at fifth points (i.e., located one fifth of the width in from the long side).

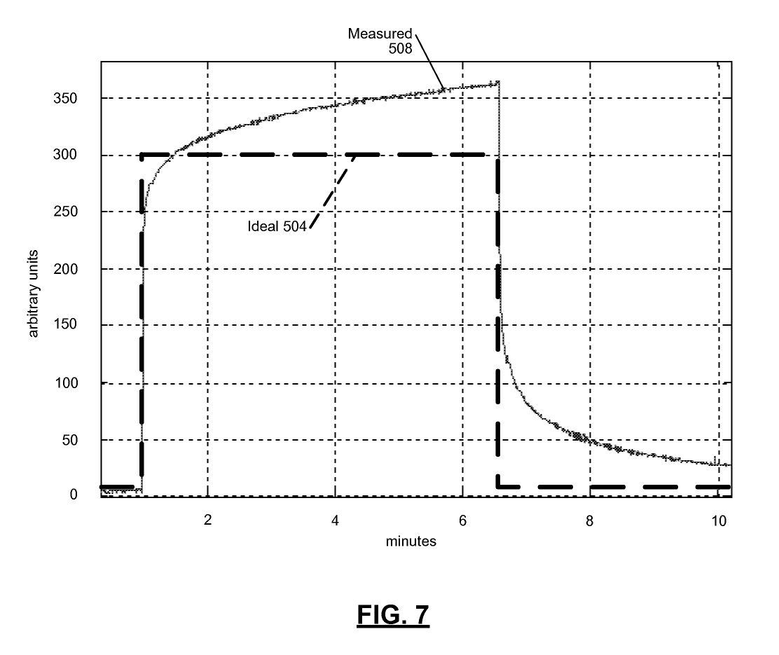

In contrast with high frequency noise, low frequency drift may occur result in decreased accuracy of force measurements. In FIG. 7, an ideal force sensor readout is shown at 504 with a force of 300 units being applied at approximately one minute and being removed at approximately six and one-half minutes. However, the measured force sensor response is shown at 508 and exhibits round-off as well as significant upward drift over the course of five minutes. Then, when the force is removed, the drift is only slowly removed.

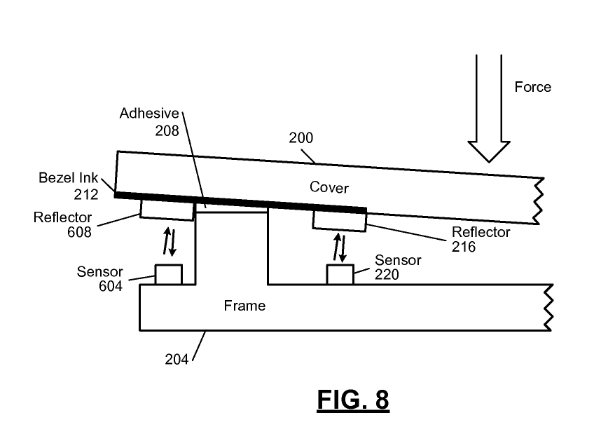

In FIG. 8, a cross-sectional view shows the cover 200 being once again deflected by a force. Adhesive 208 may be a pressure sensitive adhesive, which has a viscoelastic behavior, and does not immediately respond to the applied force but yields slowly over time to the applied force. This displacement over time can be partially removed, as described in more detail below, by establishing a baseline. When no touch has been sensed by the touch location sensors, it may be assumed that no force is being applied and that therefore any observed force is the result of viscoelastic behavior and should be accounted for as a baseline from which a force can be measured.

In various implementations, the derivative of the reading can be monitored while the baseline is being established. This derivative indicates the change of the baseline over time so that even once a force is applied, that derivative can be used to update the baseline while the force is being applied. Additionally or alternatively, another deflection sensor 604 and accompanying reflector 608 may be integrated with the touchscreen assembly. The sensor 604 and the reflector 608 are mounted outside of the frame 204 with respect to the viewable area of the display. In various implementations the position of the reflector 608 and the sensor 604 may be reversed. Similarly, the position of the sensor 220 and the reflector 216 may be reversed.

The sensor 604 generates a signal which may be referred to as a compensation signal. The compensation signal may be scaled and then subtracted from the force signal from the sensor 220 to arrive at a compensative signal. The predetermined value may be greater than one or less than one.

Note that the sensor 604 may be closer to the fulcrum portion of the frame 204 than is the sensor 220. This may mean that the deflection measured by the sensor 604 is relatively small and must be scaled by a larger predetermined value, which will also scale any noise from the sensor 604. To reduce the amount of noise, low-pass filtering such as averaging, may be applied to the compensation signal from the sensor 604. For example only, a one-second rolling average may be applied to the compensation signal.

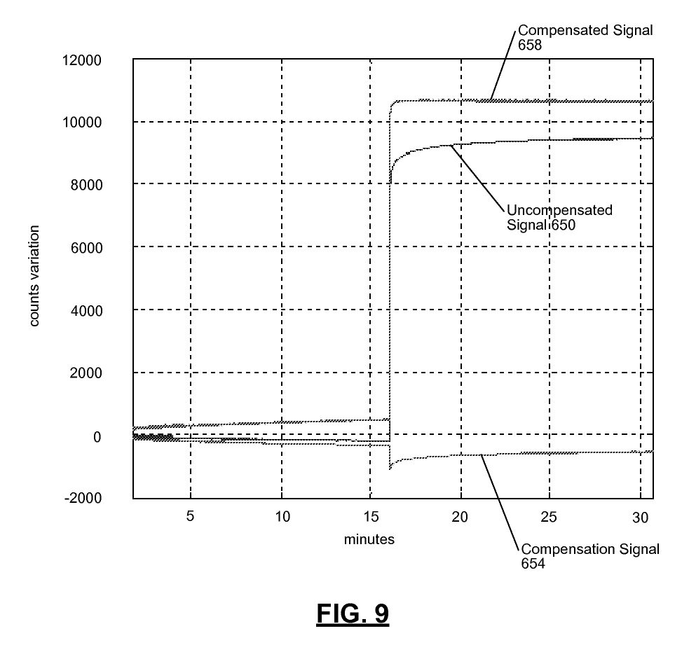

In FIG. 9, an uncompensated signal 650 is compensated by the compensation signal 654 to arrive at a compensated signal 658. The compensation signal 654 may be scaled by a predetermined value before being subtracted from the uncompensated signal 650.

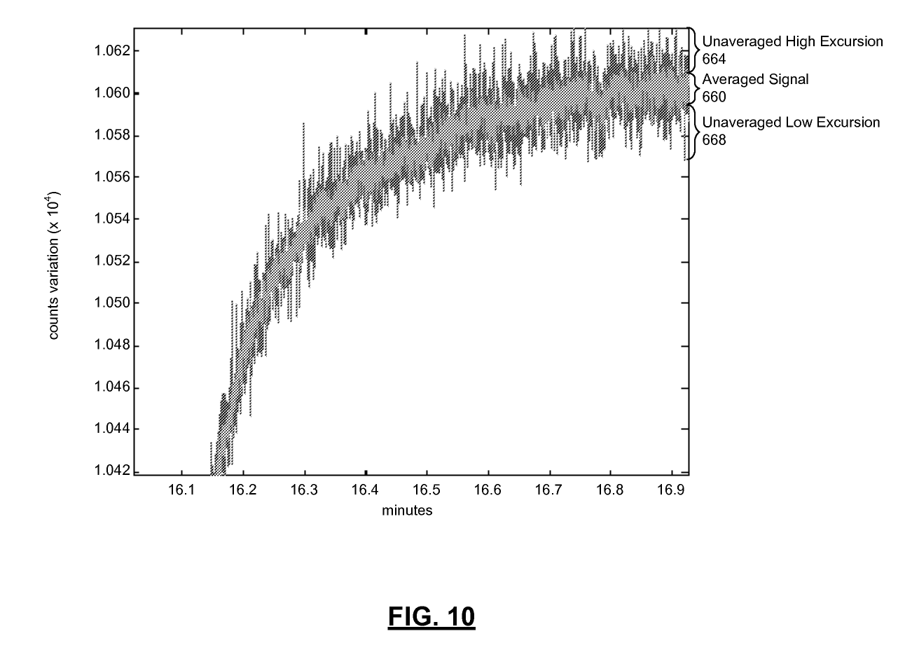

In FIG. 10, an averaged signal 660 removes high excursions 664 as well as low excursions 668 from an example raw (unaveraged) compensation signal.

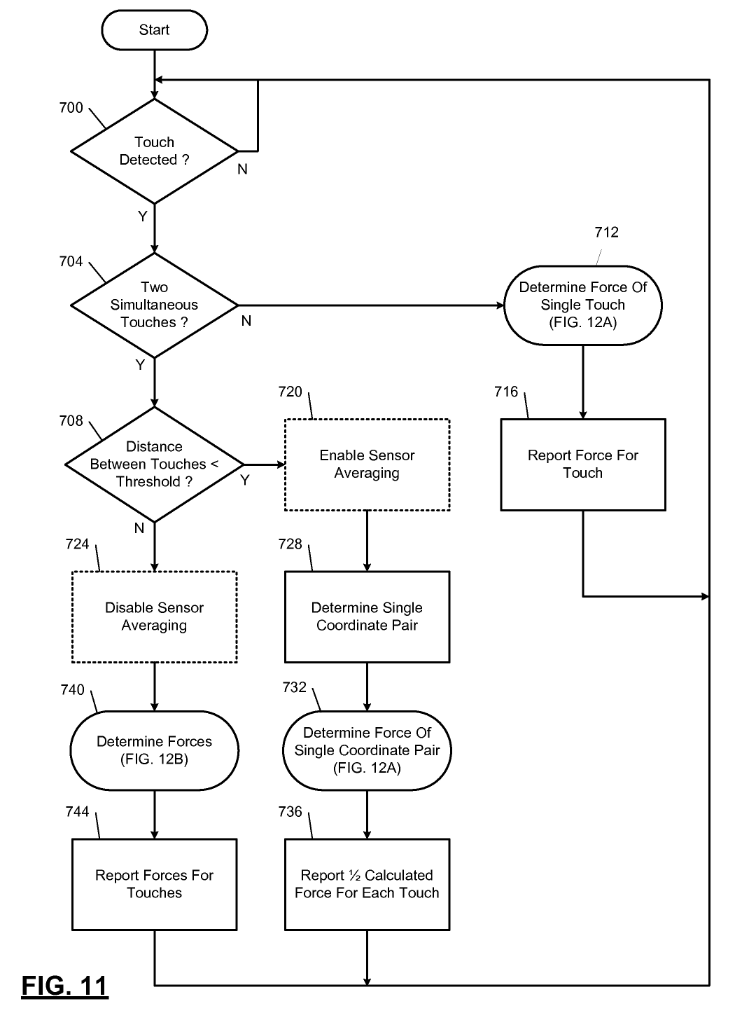

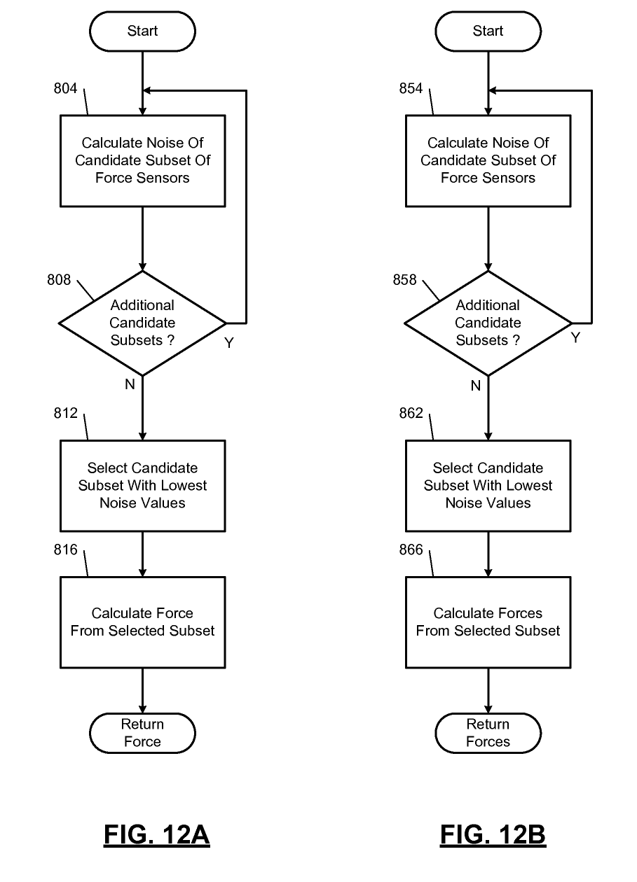

In FIG. 11, example operation of force sensing processing according to the present disclosure is described. Control begins at 700 where if a touch is detected control transfers to 704; otherwise, control remains at 700. At 704, if there are two simultaneous touches, control transfers to 708; otherwise, if there is only one touch, control transfers to 712. At 712, control determines the force of the single touch. For example, this force may be determined according to FIG. 12A. Control then continues at 716 where the determined force is reported and control returns to 700.

At 708, if the distance between the two touches is less than a threshold, control transfers to 720; otherwise, control transfers to 724. At 720, control may optionally enable force sensor averaging. This may reduce the amount of noise contributed by the force sensors at the expense of faster responsiveness to changes in force. Control continues at 728, where a single coordinate pair is determined corresponding to both touches. For example only, the coordinate pair may be determined by averaging the x-coordinates of the touches to produce an aggregate x-coordinate, and an aggregate y-coordinate may be created by averaging the y-coordinates of the two touches.

Control continues at 732, where the force of the single coordinate pair is determined according to FIG. 12A. At 736, control reports half of the calculated force for each touch. Control then returns to 700. At 724, control may disable sensor averaging to improve responsiveness. Control continues at 740, where forces corresponding to the touches are determined according to FIG. 12B. Control continues at 744, where the forces corresponding to the touches are reported. Control then returns to 700.

In FIG. 12A, control begins at 804, where noise parameters are calculated for a candidate subset of force sensors. At 808, control determines whether there are additional possible subsets of sensors to be evaluated as candidate subsets. If so, control returns to 804; otherwise control continues at 812. The candidate subsets are proper subsets of the entire set of force sensors. In other words, each subset includes fewer than all of the force sensors.

At 812, the noise parameters of all of the possible candidate subsets have been evaluated and the candidate subset with the lowest noise parameters is selected. At 816, the force corresponding to the touch is calculated from the selected subset of force sensors. Control then returns the calculated force information.

In FIG. 12B, control starts at 854, where noise parameters of a candidate subset of force sensors are determined based on a set of detected touches. Control continues at 858, where if there are additional candidate subsets to evaluate, control returns to 854; otherwise, control continues at 862. At 862, control selects the candidate subset having the lowest noise values and at 866 control calculates forces corresponding to the touches based on the selected subset. Control then returns the values of the calculated forces.

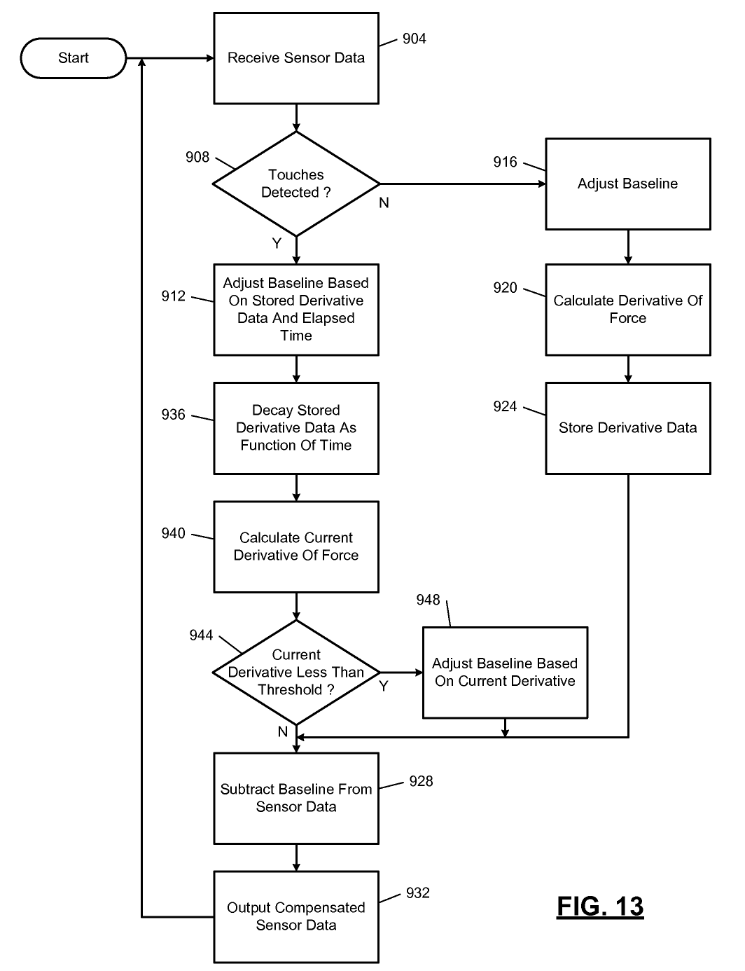

In FIG. 13, example operation of drift compensation is shown. Control begins at 904, where sensor data is received. At 908, if touch location data indicates that the one or more touches is presently occurring, control transfers to 912; otherwise control transfers to 916. At 916, no touches are currently occurring and therefore the force sensor data may be used as the new baseline.

At 920, control may evaluate the recent historical force data and determine a derivative. At 924, the derivative is stored and control transfers to 928. At 928, the baseline is subtracted from the sensor data and at 932, the compensated sensor data is output. Control then returns to 904.

At 912, touches are detected and therefore the current value of force data is at least partially based on actual applied force. However, the derivative of the force calculated in 920 may indicate that the drift trend was in a certain direction and the assumption is that trend will continue over time. Therefore, control adjusts the baseline according to the stored derivative data multiplied by the elapsed time since the last baseline adjustment. Control continues at 936, where a magnitude of the stored derivative data is decreased. This causes the stored derivative data to decay to zero over time, since the slope of the drift likely does not remain constant while touches are occurring.

At 940, a current derivative of force is calculated. This current derivative indicates whether the measured force is slowly drifting or quickly changing. At 944, control determines whether the current derivative is less than a threshold. If so, control transfers to 948; otherwise control transfers to 928. At 948, because the derivative is less than a threshold, it may be assumed that the change in the force is due to drift as opposed to a change of force from the user. The baseline may therefore be adjusted based on the current derivative. Control then continues at 928. In various implementations, 940 and 944 are skipped until the stored derivative data has decayed to zero. This may prevent double correction for drift occurring soon after a touch has begun.

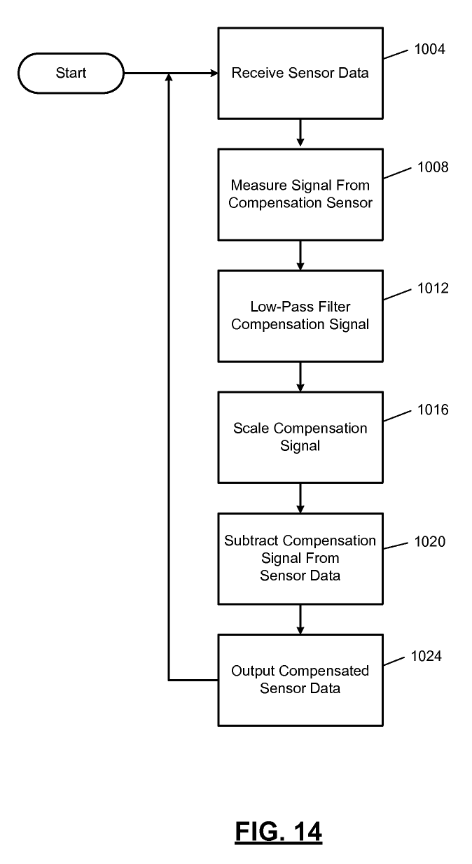

In FIG. 14, compensation based on a compensation sensor is shown. Control begins at 1004, where sensor data is received. Control continues at 1008, where control measures a signal from a compensation sensor. Control continues at 1012, where the compensation signal is low-pass-filtered, such as with a moving average. Control continues at 1016, where the compensation signal is scaled using a predetermined scaling factor. Control continues at 1020, where the compensation signal, as scaled, is subtracted from the received sensor data. At 1024, the compensated sensor data is output for use by force determining systems such as are shown in FIG. 11.

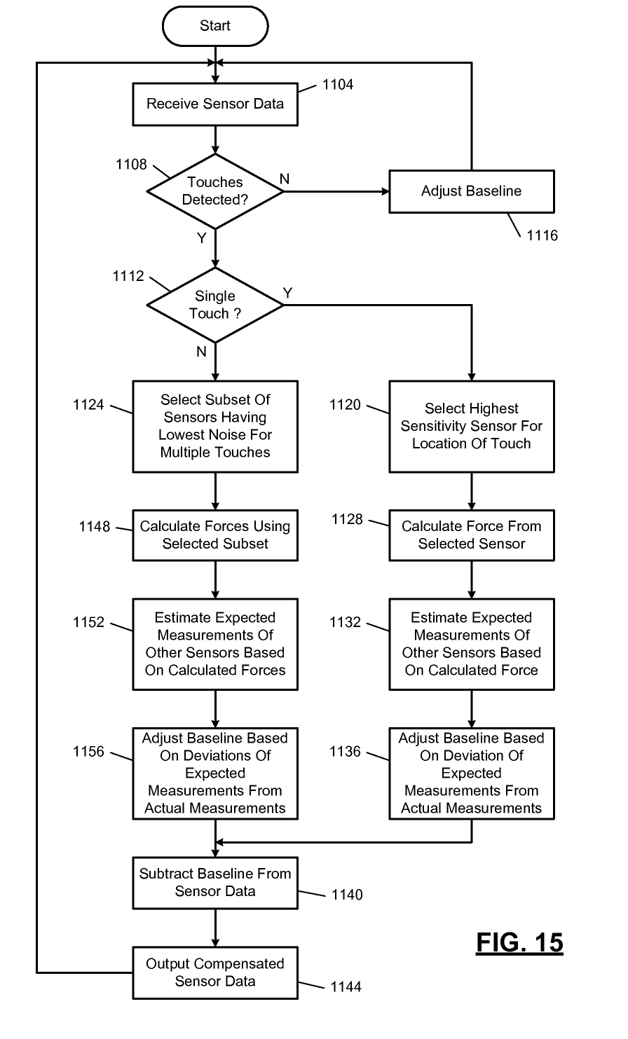

In FIG. 15, another example process for compensating force sensor data without using a compensation sensor is shown. Although shown separately, the techniques of one or more of FIGS. 13-15 may be combined to enhance the accuracy of compensation. At 1104, control receives sensor data. At 1108, control determines whether touches are detected. If so, control transfers to 1112, otherwise, control transfers to 1116. At 1116, control adjusts the baseline of the force data due to the fact that no touches are currently detected, and returns to 1104.

At 1112, control determines whether a single touch is present. If so, control transfers to 1120; otherwise control transfers to 1124. At 1120, control selects the sensor having the highest sensitivity for the location of the single touch. At 1128, control calculates the amount of force corresponding to the touch based on the data from the selected sensor. At 1132, control estimates the expected measurements of the other sensors based on the calculated force from 1128. At 1136, control determines the deviation of the expected measurements from actual measurements of the sensors and adjusts the baseline based on that deviation. Control continues at 1140. At 1140, the baseline is subtracted from sensor data, and at 1144 the compensated sensor data is output. Control then returns to 1104.

Returning now to 1124, control selects a subset of force sensors having the lowest noise for the currently occurring multiple touches. At 1148, control calculates the forces corresponding to those touches using the selected subset of sensors. For example only, when a pair of touches is detected by the touch location sensors, the subset of sensors may comprise two sensors. At 1152, control estimates the expected measurements of other force sensors based on the calculated forces from 1148. At 1156, control determines the deviations of the expected measurements of the other sensors from the actual measurements from the other sensors and adjusts the baseline accordingly. Control then continues at 1140.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory is a subset of the term computer-readable medium.

The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium include nonvolatile memory (such as flash memory), volatile memory (such as static random access memory and dynamic random access memory), magnetic storage (such as magnetic tape or hard disk drive), and optical storage.

The apparatuses and methods described in this application may be partially or fully implemented by one or more computer programs executed by one or more processors. The computer programs include processor-executable instructions that are stored on at least one non-transitory, tangible computer-readable medium. The computer programs may also include and/or rely on stored data.

What is claimed is:

1. A pressure-sensing touch system for an electronic display, the touch system comprising:
a plurality of pressure sensors, wherein each pressure sensor of the plurality of pressure sensors is configured to generate a signal indicative of pressure applied to a surface of the electronic display; and
a controller configured to (i) receive spatial coordinates of a plurality of touch events simultaneously occurring on the electronic display, (ii) select a subset of the plurality of pressure sensors, wherein the subset is a proper subset, and (iii) calculate pressure values respectively corresponding to the plurality of touch events based on the spatial coordinates and the signals from the selected subset.

2. The pressure-sensing touch system of claim 1 wherein the controller is configured to, for the plurality of touch events, (i) determine noise values for each of a plurality of candidate subsets of the plurality of pressure sensors and (ii) designate the candidate subset having the lowest noise values as the selected subset.

3. The pressure-sensing touch system of claim 2 wherein the controller is configured to, in response to the lowest noise values exceeding a predetermined noise threshold, apply a low-pass filter to the signals of the plurality of pressure sensors.

4. The pressure-sensing touch system of claim 1 wherein the controller is configured to, in response to the spatial coordinates of two of the touch events being closer than a predetermined distance threshold, calculate a combined pressure value for the two touch events.

5. The pressure-sensing touch system of claim 1 wherein the controller is configured to calibrate the signals from the plurality of pressure sensors while no touch events are occurring on the electronic display.

6. The pressure-sensing touch system of claim 5 wherein the controller is configured to continue calibrating the signals from the plurality of pressure sensors as long as no touch events are occurring on the electronic display.

7. The pressure-sensing touch system of claim 1 wherein:
the electronic display has a generally rectangular shape with first and second short sides and first and second long sides,
first and second sensors of the plurality of pressure sensors are located along the first short side,
third and fourth sensors of the plurality of pressure sensors are located along the second short side,
a fifth sensor of the plurality of pressure sensors is located along the first long side, and
a sixth sensor of the plurality of pressure sensors is located along the second long side.

8. The pressure-sensing touch system of claim 7 wherein:
the fifth sensor is centered along the first long side, and
the sixth sensor is centered along the second long side.

9. The pressure-sensing touch system of claim 1 wherein the electronic display includes a viewable area and a bezel surrounding the viewable area, and wherein the plurality of pressure sensors are located underneath the bezel.

10. The pressure-sensing touch system of claim 1 wherein:
the electronic display includes a first surface against which the touch events apply pressure,
the first surface deflects in response to the applied pressure, and
a first sensor of the plurality of pressure sensors includes an electromagnetic sensor that detects deflection of the first surface.

11. The pressure-sensing touch system of claim 10 wherein a reflector is attached to an underside of the first surface.

12. The pressure-sensing touch system of claim 10 wherein the first sensor includes an electromagnetic emitter that emits infrared light.

13. The pressure-sensing touch system of claim 10 wherein:
the first surface pivots against a fulcrum, and
the first sensor is located between the fulcrum and a center of the electronic display.

14. The pressure-sensing touch system of claim 13 wherein:
a viscoelastic material is present between the fulcrum and the first surface,
the pressure-sensing touch system further comprises an additional electromagnetic sensor that detects deflection of the first surface, and
the additional electromagnetic sensor is located on an opposite side of the fulcrum from the center of the electronic display.

15. The pressure-sensing touch system of claim 14 wherein the controller is further configured to compensate, based on deflection detected by the additional electromagnetic sensor, for displacement of the viscoelastic material.

16. A display system comprising;
the pressure-sensing touch system of claim 1;
the electronic display; and
a position-sensing device configured to generate the coordinates.

17. The display system of claim 16 wherein the touch events include at least one of (i) contact between a hand of a user and the electronic display and (ii) contact between an electrically-conductive implement and the electronic display.

18. The display system of claim 16 wherein the position-sensing device comprises a capacitive multi-touch-sensitive device.

19. A method of operating a pressure-sensing touch system for an electronic display, the method comprising:
from each pressure sensor of a plurality of pressure sensors, receiving a signal indicative of pressure applied to a surface of the electronic display;
receiving spatial coordinates of a plurality of touch events simultaneously occurring on the electronic display;
selecting a subset of the plurality of pressure sensors, wherein the subset is a proper subset; and
calculating pressure values respectively corresponding to the plurality of touch events based on the spatial coordinates and the signals from the selected subset.

20. A non-transitory computer-readable medium storing instructions, the instructions comprising:
from each pressure sensor of a plurality of pressure sensors, receiving a signal indicative of pressure applied to a surface of an electronic display;
receiving spatial coordinates of a plurality of touch events simultaneously occurring on the electronic display;
selecting a subset of the plurality of pressure sensors, wherein the subset is a proper subset; and
calculating pressure values respectively corresponding to the plurality of touch events based on the spatial coordinates and the signals from the selected subset.
